(19) United States
(12) Patent Application Publication
(10) Pub. No.: US 2005/0194300 A1
(43) Pub. Date: Sep. 8, 2005

(54) Direct chlorination system and device for city water

(76) Inventors: Tianquan Zhang, Zhengzhou (CN); Zhanjun Zhang, Zhengzhou (CN); Xianwu Liu, Zhengzhou (CN); Chunying Zhao, Zhengzhou (CN); Dongwen Shi, Zhengzhou (CN); Kexin Zhang, Zhengzhou (CN); Yan Wang, Zhengzhou (CN); Ling Shen, Zhengzhou (CN); Zhihua Mao, Zhengzhou (CN); Tianling Zhao, Zhengzhou (CN); Peng Chen, Zhengzhou (CN)

Correspondence Address: SYNNESTVEDT & LECHNER, LLP, 2600 ARAMARK TOWER, 1101 MARKET STREET, PHILADELPHIA, PA, 191072950, US

(21) Appl. No.: 11/070,735

(22) Filed: Mar. 2, 2005

(30) Foreign Application Priority Data
Mar. 5, 2004 (CN) 200410010109X

(51) Int. Cl. C02F 1/76

(52) U.S. Cl. 210/205

(57) ABSTRACT

A direct chlorination system and device characterized by feeding of liquefied chlorine into water without vaporization in a process that liquefied chlorine from a source liquefied chlorine cylinder is led to a liquefied chlorine settlement cylinder for removal of solid impurities, a metering pump for a pressurization and flow rate control at the metering pump and a liquefied chlorine feeder for mixing with and dissolving in pressurized water to become a high concentration chlorine solution which is then led to a water injector for feeding into a rapid water filter, a mixing basin and a clearing water reservoir for reaction and disinfection before city water is sent to a city water distribution network, and possessing the following merits: upgrading potable water quality, minimizing initial investment, lowering operating cost, and providing a simply but reliable, easy-to-control device that can facilitate water works automation.

### FIELD OF THE INVENTION

The present invention relates to a chlorination system and device for use in city water supply. The chlorination system being used in water works today is: Liquefied chlorine is gasified, and the gaseous chlorine is fed into water. According to the present invention, the liquefied chlorine is fed into water directly in the chlorination system.

### BACKGROUND OF THE INVENTION

Chlorination is an effective way for disinfection of city water, and has significantly lower infection and mortality rate. Furthermore, as the cost of chlorination is very low, it has been extensively used throughout the world. Till early 21^{st} century, chlorination has been the main disinfection method for city water in the world.

Basically there is a standard process for chlorination in water works, it is applied in all technical specifications, design manual and text books throughout the world, and is used in all new water works.

The current chlorination system being used is: Liquefied chlorine from a source liquefied chlorine cylinder is gasified in an evaporator, the gaseous chlorine so obtained is filtered in a filter, regulated in a vacuum regulator, enters a chlorinator for flow rate control and then a water injector to mix with, and be dissolved in pressurized water in the water injector. The chlorine solution formed in the water injector is then fed into a filtered water pipeline; and this water with chlorine is led to a clearing water reservoir via a mixing basin so that the chlorine and the filtered water are duly reacted for disinfection purpose. The water after the chlorination, after being tested to assure that it meets the potable water standard, is pumped into city water distribution network.

Basic features of the current chlorination process include:

Liquefied chlorine is supplied by gas supplier in particularly designed steel cylinder. The steel cylinder is reusable. At the water works, liquefied chlorine from the cylinder is gasified by an evaporator, and gaseous chlorine so obtained is fed into water by a specially designed chlorinator at a predetermined flow rate. For small water works, the evaporator may be omitted, and the liquefied chlorine can be gasified by warming the cylinder with air in the atmosphere.

The chlorinator is indeed a throttle valve. It controls chlorine flow by changing a cross sectional area of a chlorine passage in the valve. The chlorinator shall be micro-adjustable, and thus a larger specific volume is required for material passing through it. This is, upon change of flow rate, displacement of the valve flap must not be so small. The specific volume of gaseous chlorine is 456 times of that for liquefied chlorine (at 0° C., lata). Therefore, the liquefied chlorine must be gasified before it can enter the chlorinator. Moreover, if the liquefied chlorine is allowed to enter the throttle valve, the lowering of pressure will result in absorption of heat for vaporization and consequently the throttle valve will be blocked due to freezing.

The cross section for passing of material through the throttle valve is very small, and thus inclusion of solid particle in the flow is not allowed; otherwise the throttle valve may be blocked. The vaporization process can leave the solid impurity in the cylinder to avoid blockage. This is one of the reasons why vaporization is proceeded before chlorine is fed into water in the prior art.

Such a prior art has a lot of disadvantages:

a. It is hard to ascertain residual chlorine level, one of the water quality indices for potable water. Chlorine is an effective disinfectant, and it is toxic. Insufficient chlorine input can not provide complete disinfection effect, but excessive chlorine input is harmful to health. Therefore, residual chlorine content in city water from water works should be around an optimal level. However, the throttle valve for flow in the chlorinator is for volumetric flow control, but indeed mass flow is needed in the control of chlorine input. Furthermore, specific volume of gaseous chlorine varies significantly following the change of its pressure and temperature. Therefore, the control software for automatic chlorinator is very complicated, and manual operated chlorinator can not solve such a problem. Consequently the allowable range for residual chlorine content in city water from water works has to be very big; otherwise it is impracticable. Typical allowable residual chlorine content is as follows (varies from place to place):
Winter: 0.5-1.0 mg chlorine/liter of water
Summer: 0.8-1.2 mg chlorine/liter of water

b. Large investment is required. At least two electric evaporators and 3-8 automatic chlorinators are needed in each water works, their costs are very expensive.

c. High operating cost: As the initial cost is high, their overhaul cost and depreciation are high. The high power consumption of evaporator (about 18 kW per set) also increases the operating cost.

d. Complicated system installation and it is not easy to control, and it is not idea for water works automation.

### SUMMARY OF THE INVENTION

The main objective of the present invention is to provide a direct chlorination system and device for directly feeding of liquefied chlorine to water for disinfection purpose.

The objective of the present invention can be realized by the following system: Liquefied chlorine from a source liquefied chlorine cylinder is led to a liquefied chlorine settlement cylinder, and then flows through a liquefied chlorine pipeline into a metering pump. After a pressurization and flow rate control at the metering pump, the liquefied chlorine enters liquefied chlorine feeder where the liquefied chlorine is mixed with, and dissolved in pressurized water to become a high concentration chlorine solution. The chlorine solution is led to a water injector for further mixing and diluted with pressurized water. The diluted chlorine solution is led to a filtrated water pipe line through a pipeline, a mixing basin through another pipeline for complete mixing, a clearing water reservoir for reaction and disinfection, and finally to a city water distribution network for output from the water works. The above system can be operated automatically with either single loop or twin-loop control. In the single loop control mode, a continuous residual chlorine detection instrument is used to convert residual chlorine level in the mixing basin to an electric signal for controlling the chlorine output from a metering pump. In the twin-loop control mode, a flow meter is further installed at the rapid water filter to convert flow rate of the filtered water into an electric signal as an auxiliary control to control output from the metering pump.

The system according to the present invention has a lot of merits, such as:

1. Upgrading potable water quality:

Though volumetric flow control is applied in the metering pump (tolerance ±1%), the accuracy of output is close to that with mass flow control as the variation of specific volume is very small upon change on the liquefied chlorine temperature and pressure. An entirely different result is obtained in comparison with the using of chlorinator working with gaseous chlorine.

Application of direct feeding of liquefied chlorine by metering pump allows selection of an optimal range within the allowable range of residual chlorine level allowed by law, such as
Winter: 0.6-0.8 mg chlorine/liter of water
Summer: 0.9-1.1 mg chlorine/liter of water

Consequently a complete disinfection is assured without excessive residual chlorine content. It is good for health, and it reduces chlorine consumption.

2. Less investment required: Use of the system according to the present invention costs only ¼ of the cost of the prior art.

3. Lower operating cost: The significant saving in initial investment can greatly reduce overhaul cost and depreciation as well as power consumption for the evaporators used in the prior art.

4. Simple and reliable device, easy to control and helpful in automation of water works.

The main feature of the system according to the present invention is feeding of liquefied chlorine instead of gaseous chlorine into water, and it is invented under the following basis:

Theoretical Basis: Liquefied chlorine and gaseous chlorine are the same chemical element. They have the same atomic structure and molecular structure. They are easily soluble in water to form hypochlorous acid. Hypochlorous acid is a small neutral molecule that can penetrate into bacteria to destroy the bacteria's enzyme system and consequently kill the bacteria. Therefore, direct feeding of liquefied chlorine can provide a disinfection effect. In comparison with feeding of gaseous chlorine in the same mass, the disinfection effect is exactly the same.

Of course, liquefied chlorine and gaseous chlorine have different physical properties. To vaporize 1 kg. of liquefied chlorine into 1 kg. of gaseous chlorine, 289 kJ, or 69 kCal of thermal energy is required. The power consumption required for vaporizing 1 kg. of liquefied chlorine per hour is about 0.0823 kW or 0.0192 kCal/s. Therefore, direct feeding of liquefied chlorine into still water at 0° C. would result in formation of some drift ice that might affect normal operation of the water works. However, in practice, the minimum water temperature in clearing water reservoir is about 0.2° C. even the settlement basin is completely covered by ice in winter, and the chlorine input required for water works in only about 2 ppm of water volume. Thus, no drift ice that might affect water works operation would be formed.

Experience in industrial practice: The most efficient action to deal with leakage of liquefied chlorine cylinder is to push the cylinder into the settlement basin rapidly to avoid leakage of toxic chlorine into the atmosphere. In the settlement basin the liquefied chlorine is discharged to water from the cylinder directly. For years of practices, direct putting of liquefied chlorine into water has never cause explosion, or violent splashing or other dangerous event.

Device Available: Economically it may not be preferable to develop chlorinator for liquefied chlorine particularly for water works, and no such literature has been seen yet. In mid 20^{th} century, reciprocating diaphragm metering pump was invented for corrosive substance. Its feeding capacity, accuracy, pressure, media temperature, viscosity and solid impurity handling capacity are perfectly suitable for use in water works.

Possible problems and solutions in using of the system according to the present invention include:

Back flow of pressurized water into the metering pump and its pipeline when liquefied chlorine pressure is lower than city water pressure at the water works during winter. To prevent from this problem, a particular device, i.e., liquefied chlorine feeder is disclosed herein to prevent from strong corrosion caused by contact between chlorine and water that may damage instrument, pipes and pipe fittings, and to prevent from direct flowing of liquefied chlorine to the feeder directly without going through a pressurization process in the metering pump for flow rate control purpose when the liquefied chlorine pressure is higher than water pressure during summer.

Flowing of large solid particles into the reciprocating diaphragm metering pump together with the liquefied chlorine, though passing through of a few small impurities (diameter less than 0.1 mm) is allowed. To solve this problem, a liquefied chlorine settlement cylinder is included in the system according to the present invention. It is simply a common liquefied chlorine cylinder with an inlet valve located at its bottom and an outlet valve on the top. Liquefied chloride is led to enter the cylinder so that solid particles can be settled there before it is discharged from the outlet valve on the top of the cylinder. The top of the settlement cylinder must be located beneath the bottom of the source liquefied chlorine cylinder to prevent from vaporization of the liquefied chlorine in the settlement cylinder. The settlement cylinder is kept full of liquefied chlorine, its inlet valve and outlet valve are maintained open to connect to the source liquefied chlorine cylinder and the metering pump. Then, explosion of the settlement cylinder due to rising of temperature is impossible. On the other hand, if the inlet valve and the outlet valve are all closed, rising of the ambient temperature would rise the temperature of the liquefied chlorine in the cylinder, and consequently raise the liquefied chlorine pressure to a degree that may result in explosion of the cylinder.

Hence, in practice there must be an instruction as follows: Do not close both the inlet valve and the outlet valve of the liquefied chlorine settlement cylinder during operation, and make sure that the pipeline is connecting to the source liquefied chlorine cylinder or the metering meter to assure that gas can be discharged upon thermal expansion caused by temperature rise.”

Note: Instead of continuous chlorine feeding in the prior art, chlorine feeding becomes intermittent in the system according to the present invention as a reciprocating diaphragm metering pump is used—a basic feature of reciprocating diaphragm metering pump. As the reciprocating pump is operated at a high frequency (tens of pumping per minute), and the volume of the clearing water reservoir is relatively very big, city water will stay in the clearing water reservoir for about 1 to 2 hours. Moreover, as chlorine is highly soluble in water, the residual chlorine level in the city water from the clearing water reservoir will be even, water quality will not be affected.

### BRIEF DESCRIPTION OF THE DRAWINGS

FIG. 1 illustrates a direct chlorination system according to the present invention;

FIG. 2 illustrates a connection from a source liquefied chlorine cylinder, a liquefied chlorine settlement cylinder, a diaphragm pump to a liquefied chlorine feeder in the system according to the present invention;

FIG. 3 is a sectional view of the liquefied chlorine feeder according to the present invention;

FIG. 4 is a left side view of the device shown in FIG. 3; and

FIG. 5 is a top view of the device shown in FIG. 3.

### DETAILED DESCRIPTION OF THE EMBODIMENT

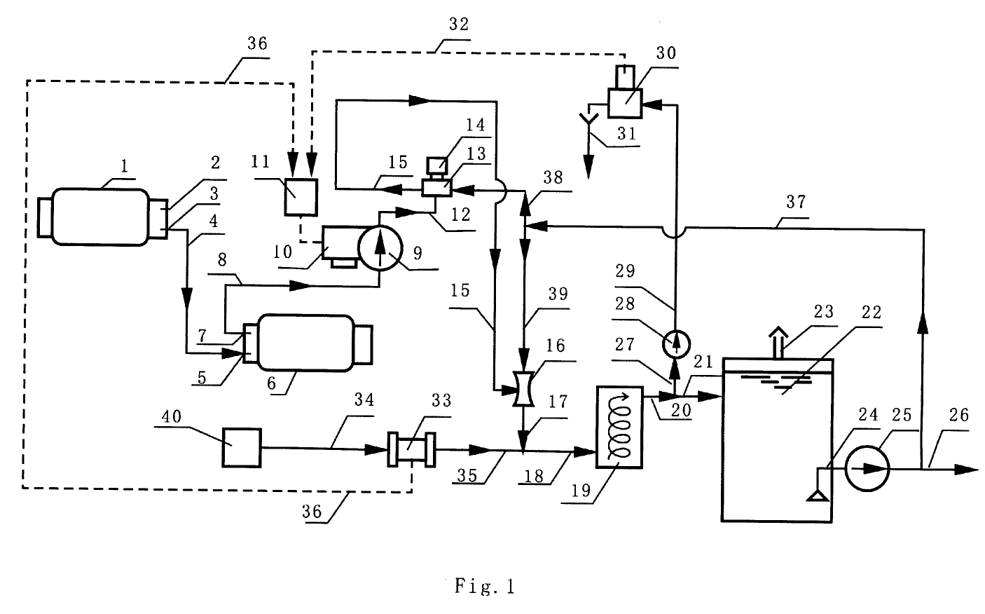

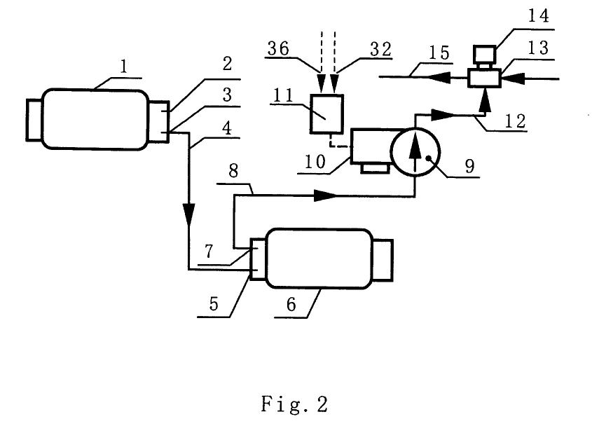

A preferred embodiment of the system according to the present invention is substantially shown in FIG. 1, in which liquefied chlorine from a source liquefied chlorine cylinder 1 passes through a chlorine valve 3, a liquefied chlorine pipeline 4, and then another chlorine valve 5 to a liquefied chlorine settlement cylinder 6. Then, the liquefied chlorine flows through a chlorine valve 7 and a liquefied chlorine pipeline 8 into a metering pump 9. After a pressurization and flow rate control at the metering pump, the liquefied chlorine enters a liquefied chlorine feeder 13 with a top tightening device 14 through a liquefied chlorine pipeline 12. Within the liquefied chlorine feeder 13, the liquefied chlorine is mixed with, and dissolved in pressurized water from a pipeline 38 to become a high concentration chlorine solution. The chlorine solution is sent to a water injector 16 through a pipeline 15. The water injector 15 is a vacuum structure to prevent from leakage of the chlorine solution. The chlorine solution is mixed with and diluted by pressurized water from a pipeline 39 before it goes to an outlet of a rapid water filter 35 through a pipeline 17, and then enter a mixing basin 19 via a pipeline 18. The diluted liquid chlorine flows into a clearing water reservoir 22 with a vent hole 23 through pipelines 20 and 21 for chlorination purpose. Water from the clearing water reservoir is then pumped by a water feeding pump 25 via a suction pipe 24 for pressurization and then led to a city water distribution network 26.

A standby chlorine valve 2 is installed in the system. When the chlorine valve 2 is to be used instead of the chlorine valve 3, the source liquefied chlorine cylinder 1 must be turned for 180° so that the chlorine valve 2 is located beneath it.

A pressurized water pipeline 37 is shunt into two lines 38 and 39 for connecting to the liquefied chlorine feeder 13 and the water injector 16.

In the system a residual chlorine detection and feeding control loop is installed. It comprises mainly a continuous residual chlorine detection instrument 30 with a discharge funnel 31. An end of the chlorine detection instrument 30 is connected to an outlet of the mixing basin 19 through a residual chlorine sampling pump 28 and its inlet 27 and outlet 29, while another end of the chlorine detection instrument 30 is connected to a control panel 11 for the metering pump's driving motor 10. Level of chlorine content in the water is shown at a continuous signal output circuit 32 at the chlorine detection instrument 30, indicated by a current magnitude ranged from 4 to 20 mA. In case the residual chlorine content detected is higher than a preset level, the control panel 11 is triggered to lower the rotation speed of the driving motor 10 in order to lower chlorine feeding rate, and vice versa.

In the said liquefied chlorine feed system there is also a water flow detection and feeding control loop. It comprises mainly a flow meter 33. The inlet of the flow meter is connected to a filtration basin 40 via a pipeline 34, and its outlet is connected to the mixing basin 19 through the pipelines 35 and 18. The flow meter is further connected to the control panel 11 for the metering pump's driving motor 10 via a continuous signal output circuit 36. Flow rate is indicated by a current magnitude ranged from 4 to 20 mA. Upon sudden increase of flow rate from the rapid water filter 40, the control panel 11 is triggered to increase the rotation speed of the driving motor 10 in order to increase chlorine feeding rate, and vice versa.

The above twin-loop automatic control system can be changed to a single-loop automatic control system by eliminating the flow meter 33 and the continuous signal output circuit 36. Of course, the use of the twin-loop automatic control system can provide a better regulation effect.

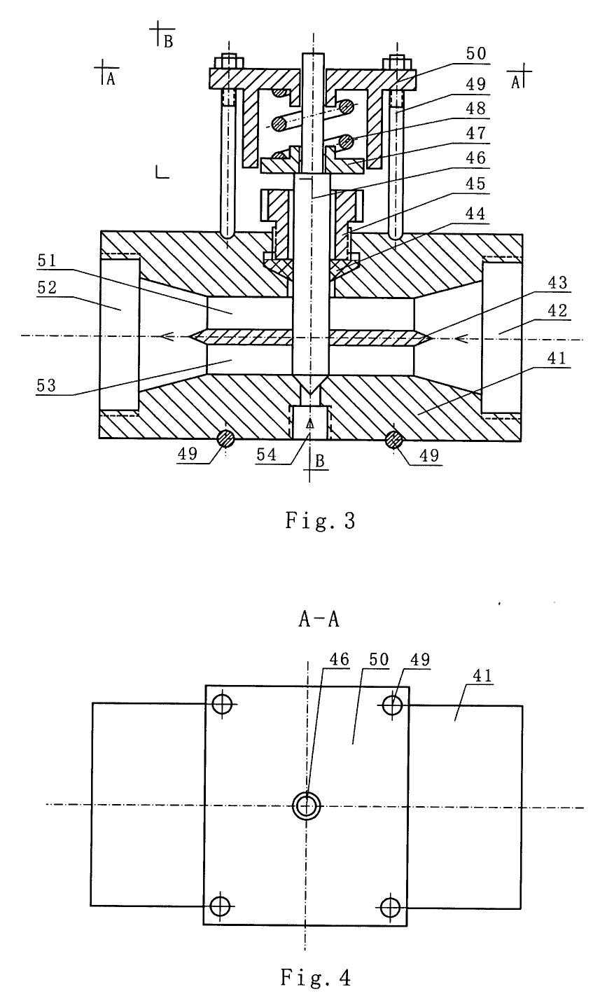

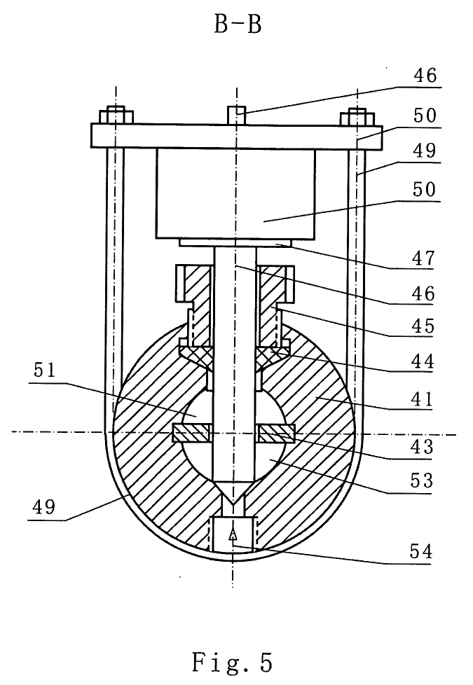

As shown in FIGS. 3, 4 and 5, the liquefied chlorine feeder 13 in the aforesaid direct chlorination system comprises a shell 41 with a water passage cavity having a pressurized water inlet port 42 at an end and a water outlet port 52 at another end, a valve stem 46 on the top of the shell 41 and passing through the water passage cavity, a liquefied chlorine input port 54 at the bottom of the shell 41 and located at a position corresponding to the front end of the valve stem 46, a gland packing 44 between the valve stem 46 and the shell 41 and compressed by a cover 45, a spring box 50 on the top of the shell 41, including therein a spring box base 47 and a pressure spring 48 to control the valve stem 46, connected to the shell 41 with U-bolts and nuts 49, and a separating plate 43 to separate the water passage cavity to two semi-circular water passage sections, namely a fresh water passage cavity 51 at the upper section and a mixing cavity 53 for mixing of the liquefied chlorine and water at the lower section. With such a structure, only fresh water will leak, and no chlorine solution will leak even the gland packing is out of function. Therefore, the environment will not be contaminated; safe operation of the system is assured.

The liquefied chlorine input port 54 is designed with a tapered outlet which can be sealed by the valve stem 46 through action of the pressure spring 48, and the resilience extended by the pressure spring 48 can be adjusted according to actual need by adjusting the U-bolts and nuts 49 so that
Output pressure at the metering pump (P₁)>Pressure extended by the pressure spring 48 (P₂)>Maximum pressure of the liquefied chlorine in summer (P₃).

The above inequality assures successful implementation of the process according to the present invention.

As the fluid can flow through the pump body upon stoppage of diaphragm metering pump, liquefied chlorine pressure is directly correlated with temperature (the pressure is 0.27 MPa, 0.56 MPa, 1.02 MPa at 0° C., 20° C. and 40° C. respectively), and city water pressure preset at water works is about 0.3 MPa, then P₂ must be greater than P₃, as shown in the aforesaid inequality, in order to assure that the liquefied chlorine will not go into the feeder out of control due to excessive high pressure during summer. On the other hand, as P₁ is greater than P₂, the liquefied chlorine can go into the water as required by opening the metering pump even the pressure of liquefied chlorine is extremely low during winter.

1. A direct chlorination system and device for disinfection of city water characterized by feeding of liquefied chlorine into water without vaporization in a process that liquefied chlorine from a source liquefied chlorine cylinder is led to a liquefied chlorine settlement cylinder for removal of solid impurities, a metering pump for a pressurization and flow rate control and a liquefied chlorine feeder for mixing with and dissolving in pressurized water to become a high concentration chlorine solution which is then led to a water injector for feeding into a filtrated water pipe line, a mixing basin and then a clearing water reservoir for reaction and disinfection before city water is sent to city water distribution network.

2. A direct chlorination system and device for disinfection of city water as claimed in claim 1, wherein the metering pump is a reciprocating diaphragm metering pump.

3. A liquefied chlorine feeder characterized by a design of a shell with a water passage cavity having a pressurized water inlet port at an end and a water outlet port at another end, a valve stem on the top of the shell and passing through the water passage cavity, a liquefied chlorine input port at the bottom of the shell and located at a position corresponding to the front end of the valve stem, and a spring box including therein a spring box base and a pressure spring to control the valve stem.

4. A liquefied chlorine feeder as claimed in claim 3 wherein the spring box is secured to the shell by means of U-bolts and nuts.

5. A liquefied chlorine feeder as claimed in claim 3 wherein the liquefied chlorine input port is tightly sealed by the said valve stem by action of the pressure spring.

6. A liquefied chlorine feeder as claimed in claim 3 wherein a gland packing is placed between the valve stem and the shell for sealing purpose.

7. A liquefied chlorine feeder as claimed in claim 3 wherein a separating plate is placed in the feeder to separate the water passage cavity to an upper passage cavity for fresh water and a lower cavity for mixing of the liquefied chlorine and water.
